(19) United States
(12) Patent Application Publication
(10) Pub. No.: US 2014/0062945 A1
(43) Pub. Date: Mar. 6, 2014

(54) METHOD FOR INCREASING A SCANNING RATE ON A CAPACITANCE SENSITIVE TOUCH SENSOR HAVING A SINGLE DRIVE ELECTRODE

(71) Applicant: CIRQUE CORPORATION, Salt Lake City, UT (US)

(72) Inventor: Brian Monson, Farmington, UT (US)

(73) Assignee: CIRQUE CORPORATION, Salt Lake City, UT (US)

(21) Appl. No.: 13/972,726

(22) Filed: Aug. 21, 2013

Related U.S. Application Data
(60) Provisional application No. 61/691,481, filed on Aug. 21, 2012.

(51) Int. Cl. G06F 3/041

(52) U.S. Cl. CPC G06F 3/0418
USPC 345/174

(57) ABSTRACT

A system and method for increasing a scanning rate, reducing the effects of noise and reducing power consumption when using a touch sensor having an electrode grid formed by co-planar but orthogonal XY electrodes, wherein the touch sensor may be used to determine the position of an object on a surface of the touch sensor in a single measurement cycle by using a single drive line that defines a touch sensor area and the XY electrodes as sense electrodes of the touch sensor.

### BACKGROUND OF THE INVENTION

1. Field of the Invention

This invention relates generally to touch sensors. More specifically, the present invention is a system and method for increasing a scanning rate using a traditional XY grid which can capture the full XY image in a single measurement when a single finger is present.

2. Description of Related Art

There are several designs for capacitance sensitive touch sensors. It is useful to examine the underlying technology to better understand how any capacitance sensitive touch sensor can be modified to work with the present invention.

The CIRQUE® Corporation touchpad is a mutual capacitance-sensing device and an example is illustrated as a block diagram in FIG. 1. In this touchpad 10, a grid of X (12) and Y (14) electrodes and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Pointing object position determination is then performed by using an equation that compares the magnitude of the two signals measured.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention.

The process above is repeated for the Y or column electrodes 14 using a P, N generator 24. Although the CIRQUE® touchpad described above uses a grid of X and Y electrodes 12, 14 and a separate and single sense electrode 16, the sense electrode can actually be the X or Y electrodes 12, 14 by using multiplexing. It should also be understood that the CIRQUE® touchpad technology described above can be modified in order to function as touch screen technology.

### BRIEF SUMMARY OF THE INVENTION

In a first embodiment, the present invention is a system and method for increasing a scanning rate, reducing the effects of noise and reducing power consumption when using a touch sensor having an electrode grid formed by co-planar but orthogonal XY electrodes, wherein the touch sensor may be used to determine the position of an object on a surface of the touch sensor in a single measurement cycle by using a single drive line that defines a touch sensor area and the XY electrodes as sense electrodes of the touch sensor.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of the components of a capacitance-sensitive touchpad as made by CIRQUE® Corporation and which can be modified to operate in accordance with the principles of the present invention.

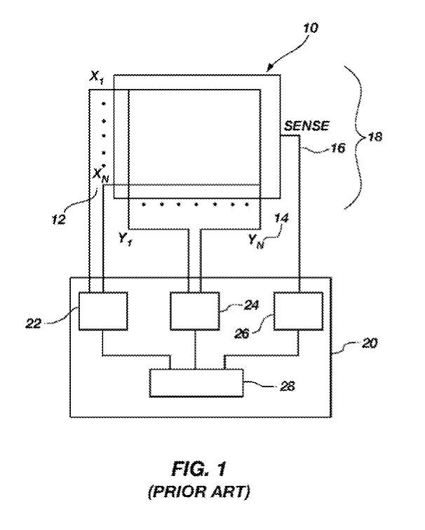

FIG. 2 is a top view of an example of the first embodiment, where a single drive electrode travels a path through the entire sensing area of the touch sensor.

FIG. 3 is a top view of a schematic diagram of an alternative embodiment of the invention where the drive and sense circuitry is combined into a single drive and sense controller.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

It should be understood that use of the term “touch sensor” throughout this document may be used interchangeably with “capacitive touch sensor device”, “touchpad”, “touch panel” and “touch screen”.

In a first embodiment of the present invention, touch sensor technology having an XY grid of electrodes may be adapted for use with the present invention. Some touch sensor systems using an XY electrode grid have been modified to include a single sense electrode that is placed on the touch sensor so that it is intertwined with the XY electrodes. Drive signals are transmitted on the X electrode grid, and sensed on the single sense electrode. Then a signal is transmitted on the Y electrode and sensed on the sense electrode in order to obtain the location of an object or objects in both the X and Y dimensions.

The first embodiment is essentially the opposite or the reverse of the process as described above. In this first embodiment, a drive electrode is placed throughout the touch sensor. In other words on a system that uses a single sense electrode, the sense electrode is now driven with a drive signal and functions as the drive electrode. The XY electrode grid is now modified so that instead of being configured to drive the different grids at different times, all of the X and Y electrodes are now configured to function as simultaneously operating sense electrodes.

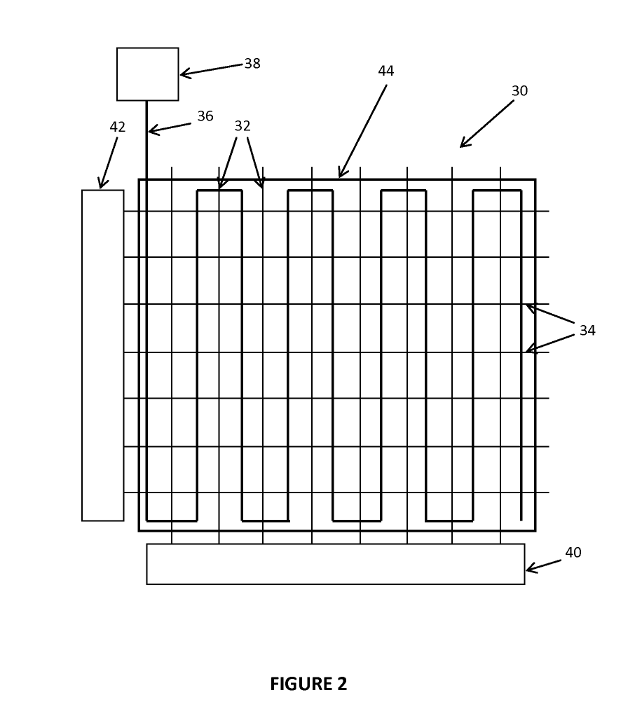

FIG. 2 is provided as an example of the first embodiment. FIG. 2 is a top view of an XY electrode grid 30 that may be used in a touch sensor 44 of the first embodiment. The touch sensor 44 includes a plurality of X electrodes 32 and a plurality of Y electrodes 34. The number of X and Y electrodes may be increased and decreased as desired. No limitation on the number of X or Y electrodes is being implied by FIG. 2.

The single drive electrode 36 is shown intertwined among the X electrodes 32 and the Y electrodes 34. It should be understood that the path of the drive electrode 36 is not limited to the path which is shown, and no limitations of a path are implied by FIG. 2. The path may cover an entire touch sensing area of the touch sensor or only a partial area. The single drive electrode 36 may have a branch, a plurality of branches or be a single wire.

It should be understood that the shape of the path may change and not be a regular serpentine pattern as shown in FIG. 2. The path may not resemble any pattern at all. The path may or may not include random direction changes. What is important is that the single drive electrode 36 be near enough to the X electrodes 32 or the Y electrodes 34 such that the detectable object may alter the capacitive coupling between the electrodes. The path may result in a single drive electrode 36 that is substantially equal to the sum of the lengths of the X electrodes 32 and the Y electrodes 34.

What is important is that the single drive electrode 36 be adjacent to all areas of the electrode grid that contain any of the X electrodes 32 or the Y electrodes 34. By virtue of trying to be adjacent to all of the X electrodes and Y electrodes 34, the length of the single drive electrode 36 will be substantially or nearly the same as the sum of the lengths of the X electrodes 32 and the Y electrodes 34.

Another result of the relatively long path of the single drive electrode 36 is that the surface area defined by the path of the single drive electrode 36 will be substantially the same as the surface area of the touch sensor 44. By stating the surface areas are similar is to suggest that the single drive electrode is adjacent so as to have a capacitive effect on all or substantially all of the X electrodes 32 and the Y electrodes 34.

The single drive electrode 36 may receive a signal from the drive circuitry 38 of the touch sensor 44. The X electrodes 32 may send signals to sensing circuitry 40 and the Y electrodes 34 may send sense signals to sensing circuitry 42. The sensing circuitry 40, 42 may generally be part of the touch sensor 44. No limitations on the placement of the sensing circuitry 40, 42 should be implied by FIG. 2.

On a surface of the touch sensor 44, a finger or other detectable object may affect the capacitive coupling between the single drive electrode 36 and the X and Y sense electrodes 32, 34. The change in capacitive coupling is detectable by the touch sensing circuitry of the first embodiment.

The position of the finger may be calculated using standard prior art position determining techniques that require more than the two measurements of the present invention. No new position determining routines are necessary.

This type of capacitance sensitive system is inherently ghosted (detects a false “ghost” image of a detectable object) when more than one finger is present on the touch sensor 30. Ghosting refers to the inability of a touch sensor to determine the actual location of a finger because it may appear to be in two different locations at the same time due to the nature of the capacitive sensing technology being used. In other words, the first embodiment may provide single axis image information.

Thus, N number of fingers may be detected in the X axis and N number of fingers may be detected in the Y axis. The X and Y positions may not be inherently correlated so anything more than one finger position will cause ghosted finger positions. The actual finger positions may then be determined by a process known as de-ghosting, by performing individual electrode traditional drive/sense measurements. In other words, the first embodiment operates very efficiently and quickly when there is a single finger present. However, for each finger that is added to the surface of the touch sensor 30, more and more measurements must be performed in order to de-ghost the image and determine the actual positions of the multiple fingers.

As the finger count increases, the improvements achieved by the first embodiment in time and power consumption may decrease. However, for single finger detection, this method and system of scanning may be the fastest that is theoretically possible, and consume the least amount of power. The first embodiment may also reduce noise or be less susceptible to noise than the prior art.

As stated above, the scan rate may be substantially faster using the first embodiment as compared to prior art methods. In other conventional scan methods, individual electrodes need to be driven sequentially or in a spread/balanced approach. Using conventional methods, the numbers of measurements may match the electrode count. Thus, for a 16×16 array, at least 16 drive measurements per axis may be required for finger detection and position determination. In contrast, in the first embodiment, only two measurements capture an image of the entire X and Y axes, thus resulting in the large increase in speed.

It was also stated that noise may be reduced in the first embodiment. Specifically, the signal on the touch sensor 30 is all received simultaneously. The advantage of receiving the sense signals on all of the sense electrodes at the same time is that any noise on the touch sensor 30 will affect all of the measurements of the sense signals by a same degree. Typically, the noise may be manifested as an offset in a signal on a sense line. Because the prior art may make measurements over a period of time, the noise signal may change, making the position determination less accurate. However, by making all of the measurements at the same time from all of the sense electrodes, the potential for noise to make the position determination less accurate may be reduced or eliminated. In other words, even if noise is present, it may be affecting all of the measurements simultaneously. Therefore it is likely that any noise being detected may be affecting all of the electrodes in substantially the same manner, but changing over time. By eliminating the variable of time, the present invention reduces vulnerability to noise. This means that position jitter should be significantly improved by this first embodiment because noise is affecting all of electrodes simultaneously.

Another advantage of the first embodiment is that a faster scan rate results in lower power usage. Because only one measurement is required to capture the entire touch sensor in both the X and Y dimensions, the active mode current is reduced by 1/16th the power of a full axis receive system and 1/64th the power of a 4 ADC system. This type of scan may be the lowest power consumption possible because it is accomplished with one single measurement.

Regarding the phenomenon of ghosting and the technique of de-ghosting, this process is well known to those skilled in the art and is taught in U.S. patent application Ser. No. 13/397,527, filed Feb. 15, 2012.

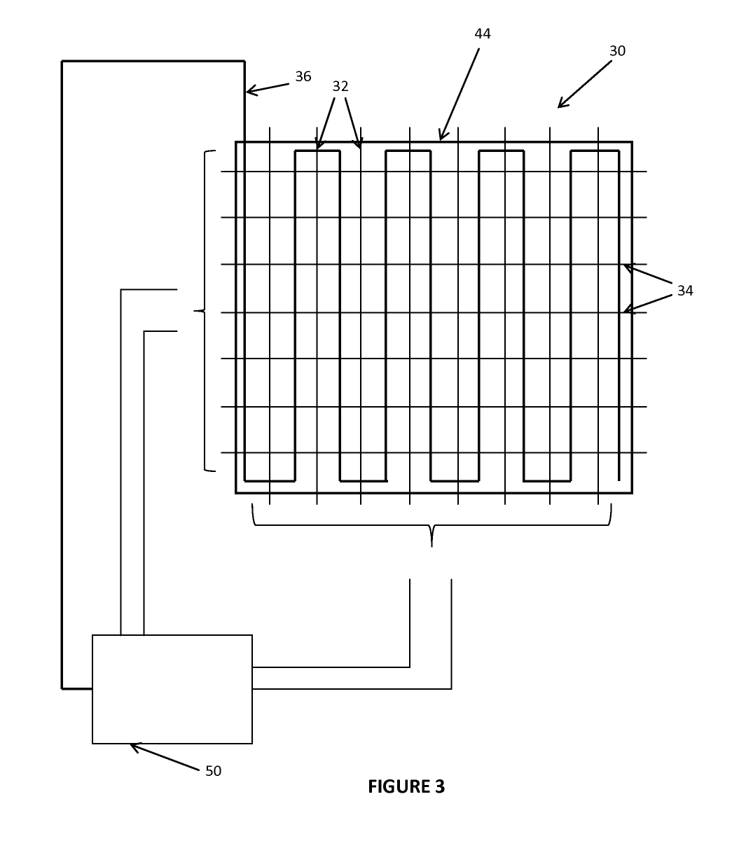

FIG. 3 is provided as an alternative embodiment of the present invention. In this figure, the drive and sense circuitry is combined into a single drive and sense controller 50 that is able to transmit drive signals and receive sense signals.

Another aspect of the invention is related to the concept of proximity sensing. It has been explained above that the single drive electrode 36 is intertwined among the X and Y electrodes 32, 34 of the electrode grid 30, while the X and Y electrodes act as a single large sense electrode.

The interesting and beneficial result is that when the single but very large drive electrode 36 is driven (toggled), the effect is to increase the projection of an electric field from the surface of the touch sensor 44. An electric field that is projected farther from the surface of the touch sensor 44 results in the ability to detect a detectable object at a greater distance from the touch sensor than is possible when using prior art methods for toggling the drive electrodes. Thus, by simultaneously toggling the single drive electrode 36 which covers a large area of the electrode grid 30, the touch sensor 44 is capable of improved proximity sensing because of the projected electric field.

Accordingly, another aspect of the invention is that by performing the toggling of single drive electrode 36, the touch sensor 44 enjoys improved electric field projection and therefore improved proximity sensing.

It is to be understood that the above-described arrangements are only illustrative of the application of the principles of the embodiments of the invention. Numerous modifications and alternative arrangements may be devised by those skilled in the art without departing from the spirit and scope of the present invention. The appended claims are intended to cover such modifications and arrangements.

What is claimed is:

1. A system for reducing the effects of noise on a touch sensor, said system comprising:
a plurality of parallel X electrodes disposed in a first plane, and a plurality of parallel Y electrodes disposed in a second plane, wherein the Y electrodes are co-planar with but orthogonal to the X electrodes;
a single drive electrode that is disposed so as to be co-planar with the plurality of X and Y electrodes, and disposed so as to define a sensing area of the touch sensor;
drive circuitry for transmitting a drive signal on the single drive electrode; and
sense circuitry for simultaneously receiving a signal from the plurality of X electrodes and the plurality of Y electrodes in a single measurement cycle, wherein any noise affecting the touch sensor is simultaneously received on the plurality of X and Y electrodes during the single measurement cycle, a position of a finger is determined during the single measurement cycle, and power is reduced because the drive signal is only transmitted for the single measurement cycle.

2. A system for increasing electric field projection from a touch sensor to obtain improved proximity sensing, said system comprising:
a plurality of parallel X electrodes disposed in a first plane, and a plurality of parallel Y electrodes disposed in a second plane, wherein the Y electrodes are co-planar with but orthogonal to the X electrodes;
a single drive electrode that is disposed so as to be co-planar with the plurality of X and Y electrodes, and disposed so as to define a sensing area of the touch sensor;
drive circuitry for transmitting a drive signal on the single drive electrode; and
sense circuitry for simultaneously receiving a signal from the plurality of X electrodes and the plurality of Y electrodes in a single measurement cycle, wherein a position of a finger is determined during the single measurement cycle, and wherein driving the single drive electrode projects an electric field farther from the touch sensor because of the large surface area of the sensing area.

3. A method for reducing the effect of noise on a touch sensor, said method comprising:
providing a plurality of parallel X electrodes disposed in a first plane and providing a plurality of parallel Y electrodes disposed in a second plane, wherein the Y electrodes are co-planar with but orthogonal to the X electrodes;
transmitting a drive signal from a single drive electrode that is disposed so as to be co-planar with the plurality of X and Y electrodes, and disposed so as to define a sensing area of the touch sensor; and
reducing the effect of noise on the touch sensor by simultaneously receiving a signal from the plurality of X electrode and the plurality of Y electrodes in a single measurement cycle, wherein any noise affecting the touch sensor is simultaneously received on the plurality of X and Y electrodes.

4. The method as defined in claim 3 wherein the method further comprises increasing a scan rate by collecting all of the information needed to determine a position of a finger during a single measurement cycle by simultaneously receiving a signal from the plurality of X electrode and the plurality of Y electrodes.

5. The method as defined in claim 3 wherein the method further comprises decreasing power requirements of the touch sensor by collecting all of the information needed to determine a position of a detectable object on the touch sensor during a single measurement cycle by simultaneously receiving a signal from the plurality of X electrode and the plurality of Y electrodes.

6. The method as defined in claim 3 wherein the method further comprises increasing electric field projection from a touch sensor to obtain improved proximity sensing by projecting an electric field from the single drive electrode that enables proximity detection of a detectable object before the objects makes contact with the touch sensor.
